(19) United States
(12) Patent Application Publication
(10) Pub. No.: US 2025/0162432 A1
(43) Pub. Date: May 22, 2025

(54) ELECTRIC VEHICLE SMART CHARGE PORT

(71) Applicant: Gillig LLC, Livermore, CA (US)

(72) Inventors: Nicholas Magnuski, Fort Collins, CO (US); William Briggs, Loveland, CO (US)

(21) Appl. No.: 18/953,767

(22) Filed: Nov. 20, 2024

Related U.S. Application Data
(60) Provisional application No. 63/600,987, filed on Nov. 20, 2023.

(51) Int. Cl. B60L 53/16; B60L 53/66

(52) U.S. Cl. CPC B60L 53/16; B60L 53/66

(57) ABSTRACT

An electric vehicle (EV) comprises a battery subsystem and a charge port. The charge port comprises a charge port connector, first and second communication circuitry, and a charge controller. The charge port connector is configured to mate with a charging station connector of a charging station configured to supply charging energy to the battery subsystem. The first communication circuitry is configured to communicate with the charging station via the charge port connector based on a first communication protocol, and the second communication circuitry is configured to communicate over a communication bus based on a second communication protocol. The charge controller is configured to control charging of the battery subsystem via the supplied charging energy based on a status of the battery subsystem.

### CROSS-REFERENCE TO RELATED APPLICATIONS

The present invention claims the benefit to and priority of U.S. Provisional Application No. 63/600,987, filed Nov. 20, 2023. The entire disclosure of the above application is incorporated herein by reference.

### TECHNICAL FIELD

The technology disclosed herein relates generally to electric vehicles and charging ports thereof.

### BACKGROUND

In the electric vehicle (EV) industry, entire vehicles and vehicle subsystems are powered by batteries. Batteries can be charged via charging stations and discharged in multiple ways, including mere use of the vehicle. To charge EV batteries, charging stations provide power to EVs from a power grid to the EV as connected by a charger. The EV can route power to one or more different charger modules, which can charge the batteries.

Existing EV power system architectures may include a charging port and a charger coupled to receive the power via the charging port. The charger may include a controller to monitor charging status, input power, and the like. However, such solutions require the charging port to be located very close to the charger to enable transmission of both the power and low-voltage communications between the charging port and the charger. The proximity requirement under these architectures may increase design complexity and increase the number of cables between the charging port and the charger.

### SUMMARY

Disclosed herein are improvements to electric vehicle (EV) charging and power subsystems, and more particularly, to charge ports of EVs. In an example embodiment, an EV is provided that includes a charge port, an AC and/or DC power charger coupled to the charge port, and a control unit coupled to the charge port and the AC and/or DC power charger. The charge port includes charger interface circuitry, one or more sensors, a controller coupled to the charger interface circuitry and the one or more sensors, power circuitry coupled to the charger interface circuitry and the controller, and a transceiver coupled to the controller.

In accordance with one aspect of the present disclosure, an electric vehicle (EV) comprises a battery subsystem and a charge port. The charge port comprises a charge port connector, first and second communication circuitry, and a charge controller. The charge port connector is configured to mate with a charging station connector of a charging station configured to supply charging energy to the battery subsystem. The first communication circuitry is configured to communicate with the charging station via the charge port connector based on a first communication protocol, and the second communication circuitry is configured to communicate over a communication bus based on a second communication protocol. The charge controller is configured to control charging of the battery subsystem via the supplied charging energy based on a status of the battery subsystem.

In accordance with another aspect of the present disclosure, an electric vehicle (EV) comprises a vehicle chassis, an exterior panel coupled to and supported by the vehicle chassis, wherein a space is formed between the vehicle chassis and the exterior panel, a vehicle control unit, and a battery subsystem. A charge port is coupled to the exterior panel within the space between the vehicle chassis and the exterior panel. The charge port comprises a charge controller comprising a vehicle communication module electrically coupled with a vehicle communication bus electrically coupled with the vehicle control unit and a connector configured to receive battery charging energy from an energy source. The connector comprises a plurality of power pins, and a plurality of communication pins electrically coupled with the charge controller. The charge port also comprises a charge source communication module electrically coupled with the plurality of communication pins.

In accordance with yet another aspect of the present disclosure, a method comprises electrically coupling a charge controller with a connector of a charge port, wherein the charge controller is located within the charge port. The method also comprises electrically coupling a charge source communication module with the charge controller and with the connector, wherein the charge source communication module is located within the charge port. The method further comprises coupling the charge port to a vehicle exterior panel within a space between the vehicle exterior panel and a vehicle chassis.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The drawings illustrate embodiments presently contemplated for carrying out the invention.

In the drawings:

FIG. 1 illustrates an example electric vehicle system in accordance with an embodiment.

FIG. 2 illustrates an example electric vehicle system in accordance with another embodiment.

FIG. 3 illustrates an example power system of an electric vehicle in accordance with an embodiment.

FIG. 4 illustrates an example architecture of an electric vehicle with a charge port integrating a charge controller in accordance with an embodiment.

FIG. 5 illustrates an example architecture of the electric vehicle of FIG. 4 in accordance with another embodiment.

FIG. 6 illustrates an example architecture of the electric vehicle of FIG. 4 in accordance with another embodiment.

FIG. 7 illustrates an example architecture of the electric vehicle of FIG. 4 in accordance with another embodiment.

The drawings are not necessarily drawn to scale. In the drawings, like reference numerals designate corresponding parts throughout the several views. In some embodiments, components or operations may be separated into different blocks or may be combined into a single block.

### DETAILED DESCRIPTION

Discussed herein are enhanced components, techniques, and systems related to power subsystems, charging components, and architecture and operation thereof, of an electric vehicle (EV). EVs often require a plurality of batteries to operate the vehicle and its various subsystems, and a charging system to charge the batteries. The charging system may include a charge port to couple to a charging station to receive power to charge the batteries. A typical electric vehicle charge port incorporates several electrical wires, including high voltage wires to perform charging but also several low voltage wires necessary to the function of the charging system. Within the vehicle, high and low voltage wires route to several electronic charging components. The path the low voltage wires run between the charge port and those components—specifically the length—must be minimized to ensure proper system function. Therefore, the locations of the electronic charging components relative to the location of the charge port are critical. This presents a challenge when designing electric vehicles, especially when large components like high voltage batteries are not mounted near the charge port. Further, communication signals to and from the charge port may be shared by multiple electronic charge components. This typically requires careful splicing of the low voltage wires and careful integration into the vehicle to achieve full functionality.

Existing EV power systems include charging ports and chargers coupled to the charging ports to receive power from a charging station. Such architectures lack flexibility, however, as charge controllers are included in one or more of the chargers, so the charging port may need to connect to the chargers using both high-voltage transmission lines to provide the power and low-voltage cabling to provide communications and data between the chargers and charging port. The low-voltage cabling may require the charging port and chargers to be near each other in the EV and within the EV power system to avoid interference and ensure reliable transmission of the communications.

Instead, disclosed herein is a Smart Charge Port that incorporates the charge coupler housing, a controller, and in some cases high and/or low voltage harnesses. The Smart Charge Port may also include components for voltage sensing, current sensing, high voltage switching (e.g., contactors), and charge status communication to the exterior of the vehicle. The Smart Charge Port works by performing low voltage communication between the charge port and the electronic charging components by including a controller that can communicate with these components via a communication network (e.g., controller area network (CAN)) and associated communication protocols (e.g., Ethernet, LIN). The Smart Charge Port may also provide sensor data over CAN that is not normally provided by a typical charge port, such as voltage and current. The Smart Charge Port could shut off current flow with an integrated contactor. Finally, the Smart Charge Port could provide vehicle charging information, such as the current state of charge or the existence of any errors, to the vehicle user by means of external indicators such as LED lights. Advantageously, the electronic charging components are already connected to each other via the communication network, so the amount of necessary low voltage wiring may be reduced, and the system sensitivity to wiring routing and splicing can be reduced. In other solutions, the controller that is part of the Smart Charge Port is normally housed elsewhere on the vehicle. By including the controller in the Smart Charge port, charger design and integration may be simplified, which may not only reduce component costs for AC and DC chargers, but also may increase reliability of vehicle charging functions. Thus, such a topology may reduce cost of the EV power system design, design complexity of the EV power system, and latency between the power system and other components, systems, and subsystems of the EV.

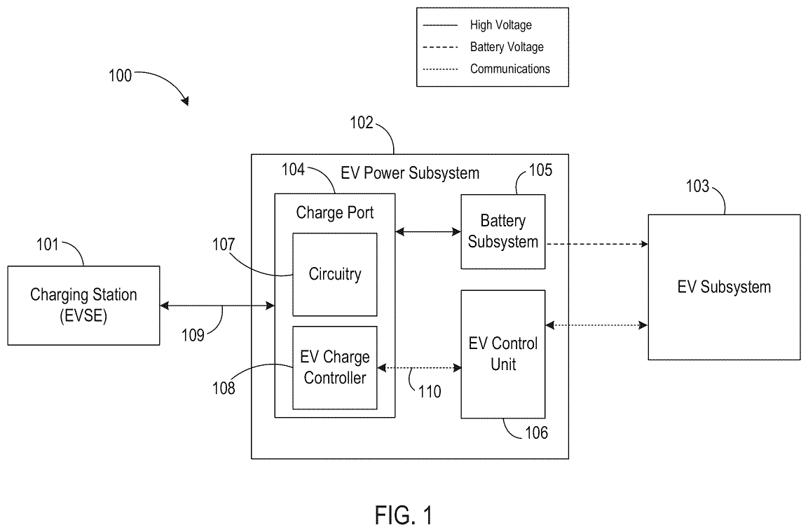

FIG. 1 illustrates an example electric vehicle system in accordance with an embodiment. FIG. 1 shows system 100, which includes charging station 101, electric vehicle (EV) power subsystem 102, and EV subsystem 103. EV power subsystem 102 includes charge port 104, battery subsystem 105, and EV control unit 106. Charge port 104 further includes circuitry 107 and EV charge controller (EVCC) 108.

Charging station 101 is representative of an EV charging station, or another power source, capable of providing power to charge an EV (e.g., an all-electric vehicle, a plug-in hybrid EV, a hybrid EV). For example, charging station 101 may provide power from a grid or a generator, which can be provided to an EV via charge port 104 of EV power subsystem 102.

EV power subsystem 102 is representative of a subsystem onboard an EV configured to receive power from charging station 101 and provide the power to charge the batteries of battery subsystem 105. EV power subsystem 102 may also provide power and communications to downstream subsystems and components (e.g., EV subsystem 103).

In various examples, EV power subsystem 102 includes charge port 104 (e.g., an EV charging connector) to interface with charging station 101 to receive input power from charging station 101 and to provide power to the battery subsystem 105. Charge port 104 may include circuitry 107 and EV charge controller 108. More specifically, charge port 104 may be an EV charging connector including EV charge controller 108 to improve communication between the EV power subsystem 102 and the EV supply equipment (EVSE) (e.g., charging station 101).

Circuitry 107 may be representative of various electrical components, hardware components, circuits, digital logic components, and the like. For example, circuitry 107 may include a port, port circuitry, interface circuitry, power circuitry, power electronics, transceiver circuitry, sensors and more. In some examples, circuitry 107 may follow SAE J1772 charging standards or any other standards compatible with components of EV power subsystem 102. Some additional exemplary standards include ISO 15118 and DIN 70121. The circuitry 107 may be configured to communicate with the charging station 101 via power-line communication (PLC) protocols or via other protocols specified in industry standard definitions.

It follows that charging station 101, which includes a charging cable 109, can be physically coupled with circuitry 107 and EV charge controller 108 of charge port 104 for communicating with the EV power subsystem 102. The charging cable 109 also couples power from charging station 101 to EV power subsystem 102 for supply to the battery subsystem 105. While circuitry 107 is described as exemplifying components that implement J1772 charging standards and operations, additional, fewer, or different components and elements to implement other charging standards may be implemented.

EV charge controller 108 is representative of a control device that can establish a communication network with other elements of EV power subsystem 102, EV subsystem 103, and other downstream subsystems (not shown). EV charge controller 108 can monitor the status of EV power subsystem 102, the status of charge port 104, the status of batteries 105 coupled to the chargers, and the like. EV charge controller 108 may include one or more processors or processing devices and accompanying circuitry. Examples of the processors include a general processing unit, a central processing unit (CPU), a microcontroller, a programmable logic controller, a digital signal processor, an application-specific integrated circuit (ASIC), field-programmable logic devices, a security module (e.g., for cryptographic operations) and the like, as well as any combination or variation thereof.

In various examples, EV charge controller 108 may be configured to sense a power from circuitry 107 to begin operating. EV charge controller 108 may be configured to identify the amount of power being provided to charge port 104 from charging station 101 and the amount of power being transmitted from charge port 104 to battery subsystem 105. EV charge controller 108 can determine a status of charge port 104 based on the amount of input power received and can determine a status of battery subsystem 105 based on the amount of power provided. The statuses may include indications of whether the batteries coupled to the chargers are charged, not charged, partially charged (e.g., a percentage), for example.

EV charge controller 108 may be coupled to EV control unit 106 via a communication network 110. EV charge controller 108 can establish the communication network 110 among the elements of EV power subsystem 102. In some examples, such components are coupled together wirelessly via the wireless communication network. In other examples, such components may be physically coupled together via low-voltage cabling, such as Ethernet cabling to establish the communication network among elements of EV power subsystem 102.

EV control unit 106 is representative of a control module of the EV configured to control EV operations and provide power to various subsystems of the EV for performance of such EV operations. EV control unit 106 may include various hardware components, circuitry, power electronics, processors, and other components capable of providing functionality to control operations of the EV and subsystems thereof. EV control unit 106 may receive indications of status, among other indications, via the communication network established between EV control unit 106 and EV charge controller 108, For example, based on an indication that the batteries 105 are charged, EV control unit 106 may provide signals to EV subsystem 103 to perform further operations to enable functionality of the EV, such as driving the EV, turning on sensors or electronics onboard the EV, or the like.

It follows that EV subsystem 103 may represent one or more subsystems of the EV other than the EV power subsystem 102. For example, EV subsystems 103 may include an EV control subsystem, a drivetrain subsystem, or any other subsystem or component of an EV.

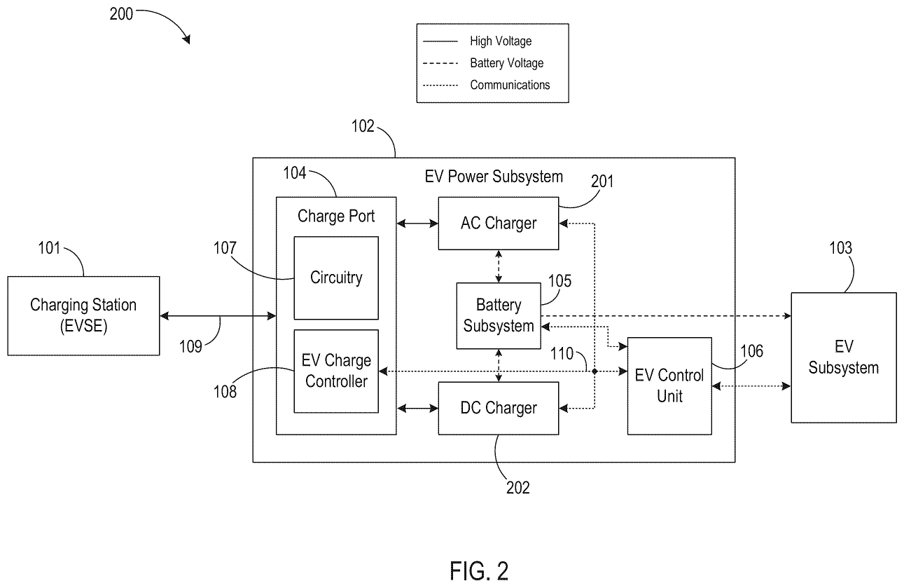

FIG. 2 illustrates an example power subsystem 200 of an electric vehicle in accordance with an embodiment. Power subsystem 200 is an embodiment of the system 100 of FIG. 1, and components and their functions in common between systems 100 and 200 may not be repeated for brevity. However, any such common components are described above with respect to FIG. 1.

The power subsystem 200 of FIG. 2 includes an AC power charger 201 and a DC power charger 202. In another embodiment, only the AC charger 201 or the DC charger 202 is included. The EV power subsystem 102 is configured to receive power from charging station 101 and provide the power to the AC charger 201 and/or the DC charger 202. The charge port 104 can transfer received AC power to AC charger 201 for converting the received AC power from AC to DC and can transfer received DC power to DC charger 202 for converting the received DC power from one DC voltage to another DC voltage (e.g., stepped up or down) to provide charging power to connected batteries 105. Additionally, the AC or DC chargers 201, 202 may convert the input power to a low-voltage power to operate EV charge controller 108 and other components on the EV.

The EV charge controller 108 can further monitor the status of the power chargers (AC power charger 201, DC power charger 202). In this manner, the EV charge controller 108 may be configured to identify the amount of power being provided to charge port 104 from charging station 101 and the amount of power being transmitted from charge port 104 to AC power charger 201 and to DC power charger 202. EV charge controller 108 can determine a status of charge port 104 based on the amount of input power received and can determine a status of AC power charger 201 and DC power charger 202 based on the amount of power provided to respective chargers. The statuses may include indications of whether the chargers are charging or not charging; whether the batteries coupled to the chargers are charged, not charged, partially charged (e.g., a percentage), etc.; and similar indications.

EV charge controller 108 may be coupled to AC charger 201, DC charger 202, and EV control unit 106 via communication network 110. EV control unit 106 may receive indications of status, among other indications, via the communication network 110 established between EV control unit 106, EV charge controller 108, AC charger 201, and DC charger 202. EV control unit 106 may perform various operations based on the statuses received over the communication network during run-time operations of the EV. For example, based on an indication that the batteries 105 are charged (by way of AC charger 201 and/or DC charger 202), EV control unit 106 may provide signals to EV subsystem 103 to perform further operations to enable functionality of the EV, such as driving the EV, turning on sensors or electronics onboard the EV, or the like.

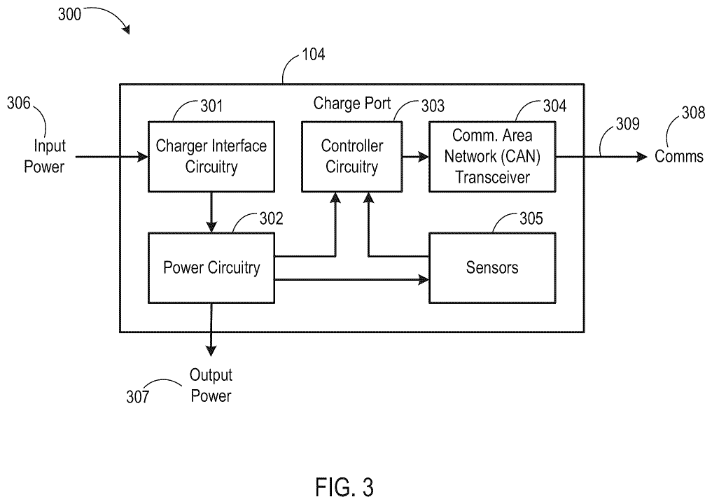

FIG. 3 illustrates an example power subsystem 300 of an electric vehicle in accordance with an embodiment. FIG. 3 includes charge port 104 of FIG. 1 and components thereof. Charge port 104 further includes charger interface circuitry 301, power circuitry 302, controller circuitry 303, communications area network (CAN) transceiver 304, and sensors 305. The components of charge port 104 may be representative of elements of circuitry 107 and/or EV charge controller 108 of FIG. 1 or FIG. 2.

Charge port 104 may be representative of a port and controller combination onboard an EV, such as in an EV power subsystem (EV power subsystem 102 of FIG. 1), capable of interfacing with a charging station (charging station 101 of FIG. 1) and chargers (e.g., AC charger 201, DC charger 202 of FIG. 2) and batteries (e.g., battery subsystem 105) of an EV. Charge port 104 may include various hardware components and electronic components, such as charger interface circuitry 301, power circuitry 302, controller circuitry 303, CAN transceiver 304, sensors 305, and more.

Charger interface circuitry 301 may be representative of one or more ports, couplings, connectors, housing, or other connection devices capable of physically and electrically coupling a charging station to the EV to receive input power 306. For example, charger interface circuitry 301 may include components to follow J1772 charging standards, or any other standards compatible to charge batteries of the EV.

Charger interface circuitry 301 may be coupled to provide input power 306 to power circuitry 302. Power circuitry 302 may be representative of one or more power converters, inverters, and other power electronics. For example, power circuitry 302 may include an AC-to-DC converter to provide DC power to controller circuitry 303 and sensors 305, another AC-to-DC converter to provide DC power (e.g., output power 307) to a DC charger (e.g., DC charger 202). Power circuitry 302 may output AC power (e.g., output power 307) to an AC charger (e.g., AC charger 201). Power circuitry 302 may also include a contactor to control the flow of current between power circuitry 302 and internal components of charge port 104 and components external to charge port 104.

Controller circuitry 303 may be representative of a control device (e.g., EV charge controller 108) that can establish a communication network 110 with other elements of charge port 104, EV power subsystem 102, EV subsystem 103, and other downstream subsystems of an EV, monitor statuses of charge port 104, EV power subsystem 102, batteries coupled to the chargers of the EV power subsystem 102, sensors 305, CAN transceiver 304, and the like. Controller circuitry 303 may include one or more processors or processing devices and accompanying circuitry. Examples of the processors include a general processing unit, a central processing unit (CPU), a microcontroller, a programmable logic controller, a digital signal processor, an application-specific integrated circuit (ASIC), field-programmable logic devices, security modules, and the like, as well as any combination or variation thereof.

During vehicle charging, the controller circuitry 303 is responsible for coordinating energy flow between the vehicle and the Electric Vehicle Supply Equipment (EVSE), as well as monitoring and managing the inputs and outputs at the charge port. It communicates with the EV Control Unit (EVCU) (e.g., EV control unit 106) or other controllers on the CAN, and with the EVSE via low voltage wiring, Wi-Fi, or other interfaces. It can lock and unlock the actuator on the charge port and sense its current state. The EVCC may be able to read inputs from charge port temperature, current, and voltage. It may be able to operate LED's that indicate energy flow status such as charge state. Finally, it may be able to power itself up or down based in low voltage inputs.

Sensors 305 may be representative of various sensors of the EV, and more specifically, sensors of the EV power subsystem, such as voltage sensors, current sensors, temperature sensors, and the like. Sensors 305 may further include indicators or lights capable of communicating vehicle charging status information. Sensors 305 can be powered by power circuitry 302 and provide indications of measurements to controller circuitry 303.

CAN transceiver 304 is representative of transmitter and receiver circuitry capable of providing and receiving communications 308 from other elements of an EV power subsystem and other EV subsystems over a communication bus 309. For example, CAN transceiver 304 may include one or more antennas, amplifiers, buffers, mixers, oscillators, and the like. CAN transceiver 304 can establish provide communications 308, representative of signals indicative of various statuses, data, and other communications, downstream as directed by controller circuitry 303.

In various examples, power circuitry 302 may be coupled to one or more chargers via physical transmission lines or wires. CAN transceiver 304, however, may be wirelessly coupled to other elements via the wireless communication network established via controller circuitry 303 and CAN transceiver 304. Advantageously, charge port 104 may eliminate the need for low-voltage cabling between charge port 104 and the chargers of the EV as controller circuitry 303 of charge port 104 can obtain statuses of the EV power subsystem and provide communications 308 directly to a control unit of the EV (e.g., EV control unit 106 of FIG. 1) as opposed to communicating with the chargers via low-voltage cabling and providing such communications from one or more of the chargers of the EV power subsystem as in existing systems.

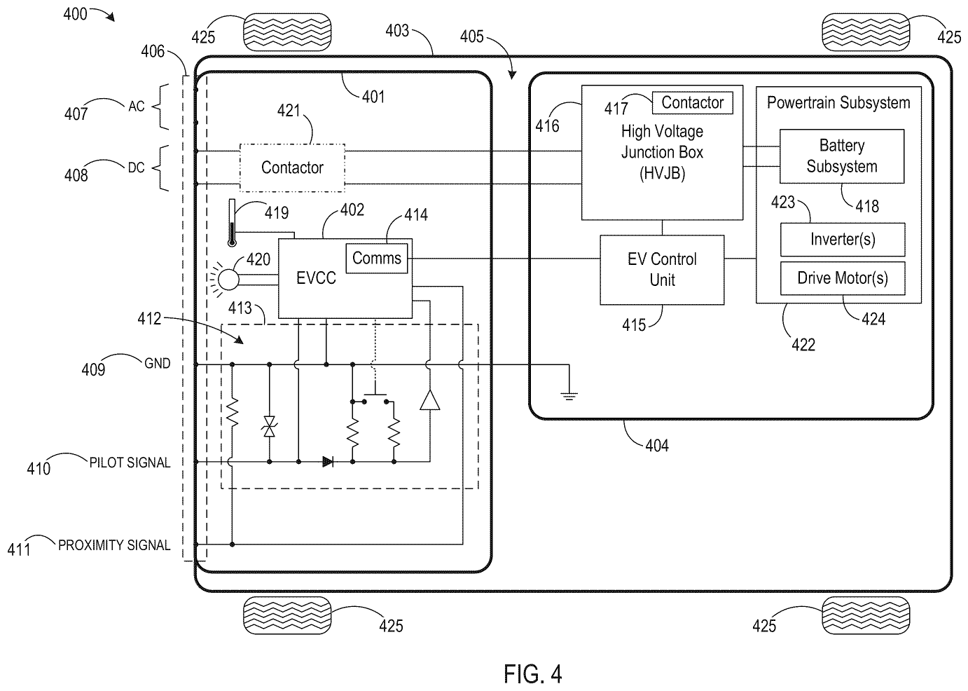

FIG. 4 illustrates an example architecture of an electric vehicle (EV) 400 with a charge port 401 integrating an EV charge controller 402 in accordance with an embodiment. Charge port 401 and EV charge controller 402 implement embodiments of the charge port 104 and EV charge controller 108 discussed above. EV 400 has a vehicle exterior 403 including exterior panels such as door panels, fender panels, trunk lid, hood, roof, etc. The vehicle exterior 403 are attached to and supported by a vehicle chassis 404 including a vehicle frame in an example. Charge port 401 is positioned within a space 405 between one or more of the panels of the vehicle exterior 403 and the vehicle chassis 404. In one embodiment, charge port 401 is attached to an inside surface of the vehicle exterior 403 and is accessible from outside the EV 400 via a charge port door (not shown) configured to expose a portion of the charge port 401 for engagement with a charging station such as the EVSE or charging station 101 of FIG. 1.

The charge port 401 includes a connector 406 configured to mate with an EVSE connector attached to an end of an EVSE charging cable (e.g., charging cable 109 of FIG. 1). In some embodiments, connector 406 includes pin connections configured to receive power and communications from the EVSE. As illustrated, connector 406 includes AC pins 407, DC pins 408, a ground (GND) pin 409, a pilot signal pin 410 (e.g., a “control pilot” signal pin), and a proximity signal pin 411 (e.g., a “plug present” signal pin). In this embodiment, AC, DC, and GND pins 407-409 are power pins, and pilot and proximity signal pins 410-411 are communication pins configured to communicate a control pilot signal and a proximity pilot signal between the EV 400 and the EVSE. As shown in FIG. 4, some pins may not be used in some EVs as determined by the vehicle manufacturer. For example, EV 400 does not use AC power that may be provided by the EVSE. As such, AC pins 407 may be included and not connected to any further circuitry, or AC pins 407 may be eliminated, leaving a void in the connector 406 in their place.

According to embodiments described herein, charge port 401 has integrated therewith the EV charge controller 402 together with communication circuitry 412 of a communication module 413 designed according to a communication protocol determined for communications between an EVSE and an EV coupled thereto for charging. An example schematic of at least a portion of the communication circuitry 412 is illustrated and may be suitable for use with an SAE J1772 connector and its communication protocol. As shown, the inclusion of the communication circuitry 412 within the charge port 401 terminates the communication with the EVSE within the charge port 401 such that SAE J1772 communications do not extend beyond the space 405 and into the interior of the vehicle chassis 404. By terminating signals on the pilot and proximity signal pins 410, 411 within the charge port 401 external to the vehicle chassis 404, additional wiring length for the proximity and pilot signals beyond the charge port 401 that can reduce communication reliability with the EVSE over the proximity and pilot lines can be eliminated.

Terminating the proximity and pilot signals via the pilot and proximity signal pins 410, 411 includes terminating the signals at the EV charge controller 402 also located within the charge port 401. The EV charge controller 402, based at least on the proximity and pilot signals, controls charging of the batteries within the EV 400. Such charging control includes communicating, via a vehicle communication subsystem 414, with an EV control unit 415 (e.g., EV control unit 106 of FIG. 1) located within the vehicle chassis 404. The vehicle communication subsystem 414 may be based on a CAN protocol as described herein. However, other communication protocols different from the protocol used by the SAE J1772 standard may be used.

In one embodiment, the EV control unit 415 is located close to a high voltage junction box (HVJB) 416 coupled to receive charging energy from the EVSE via the DC pins 408 as shown in the embodiment of FIG. 4. The HVJB 416 can be designed to route power between the high voltage battery packs and the tractive drive subsystem, and to high voltage accessories. It routes power between charging equipment and the high voltage batteries, and possibly to the high voltage accessories. The HVJB 416 has an enclosure with wires and busbars and may include sensors, switches, fuses, and contactors 417 and has provisions for being mounted to the vehicle, electrical grounding, and includes some combination of lug or connector interfaces. The HVJB 416 may perform additional functions such as pre-charge, discharge, opening and closing of circuits, voltage sensing, current sensing, temperature sensing, isolation monitoring, and safety interlocking.

The HVJB 416 may include a contactor 417, as shown in one example, for coupling or decoupling DC charging energy received at the DC pins 408 with a battery subsystem 418 for charging batteries within the subsystem 418. However, in some embodiment, the contactor 417 is not included, and DC charging energy is supplied to the HVJB 416 and to the battery subsystem 418 during any charging energy delivery by the EVSE. In this manner, communications between the EV charge controller 402 and the EVSE via the communication circuitry 412 can instruct the EVSE to provide or cease providing charging energy as determined by the EV charge controller 402. As disclosed above, sensors such as sensors 305 of FIG. 3 may provide status information indicating charging status information. Using such sensors, the EV charge controller 402 may determine whether charging energy from the EVSE should be connected to or disconnected from the battery subsystem 418. Sensors detecting state-of-charge status for the battery subsystem 418 may be located within or adjacent to the battery subsystem 418, the HVJB 416, the EV control unit 415, or some other location within the vehicle chassis 404 or the charge port 401. Communication between the state-of-charge sensor and the EV charge controller 402 may be through the vehicle communication subsystem 414 in one example.

With the EV charge controller 402 positioned within the charge port 401, other components directly coupled with the EV charge controller 402 outside of the protocol of the vehicle communication subsystem 414 may be used. As illustrated, a temperature sensor 419 within the charge port 401 may be used to measure temperatures within or around the charge port 401 and its components. During a charging process, for example, the temperature sensor 419 may be used to measure a temperature that, in response to indicating a measured temperature above a first threshold, indicates that the charging process should be stopped even though a state-of-charge of the battery subsystem 418 is not at a maximum value. In another example, a visual indicator 420 such as a light-emitting diode may be controlled to visually indicate a charging status to an observer having visual access with the charge port 401.

As shown in phantom, a contactor 421 may be included within the charge port 401 for controlling charging energy supply to the HVJB 416. The contactor 421 may be used in place of the contactor 417 in one example.

As illustrated, battery subsystem 418, in addition to being able to be associated with a power subsystem such as EV power subsystem 102 of FIG. 1, may be further associated with a powertrain subsystem 422. The EV control unit 415 may be connected to the powertrain subsystem 422 for controlling the EV 400 outside of a charging process. The powertrain subsystem 422 may include, for example, one or more inverters 423 and one or more drive motors 424 coupled to drive wheels 425 for propelling the EV 400 in a drive direction (e.g., forward or reverse) according to a drive mode selection (e.g., “drive” or “reverse”).

While FIG. 4 illustrates that battery subsystem 418 and powertrain subsystem 422 are located within the vehicle chassis 404, some or all of each of the battery subsystem 418 and powertrain subsystem 422 may be located outside of the vehicle chassis 404. For example, drive motors 424 may be located adjacent to drive wheels and external to the vehicle chassis 404. Further, placement of all or a portion of the battery subsystem 418 outside of the vehicle chassis 404 may be advantageous for weight distribution or other purposes.

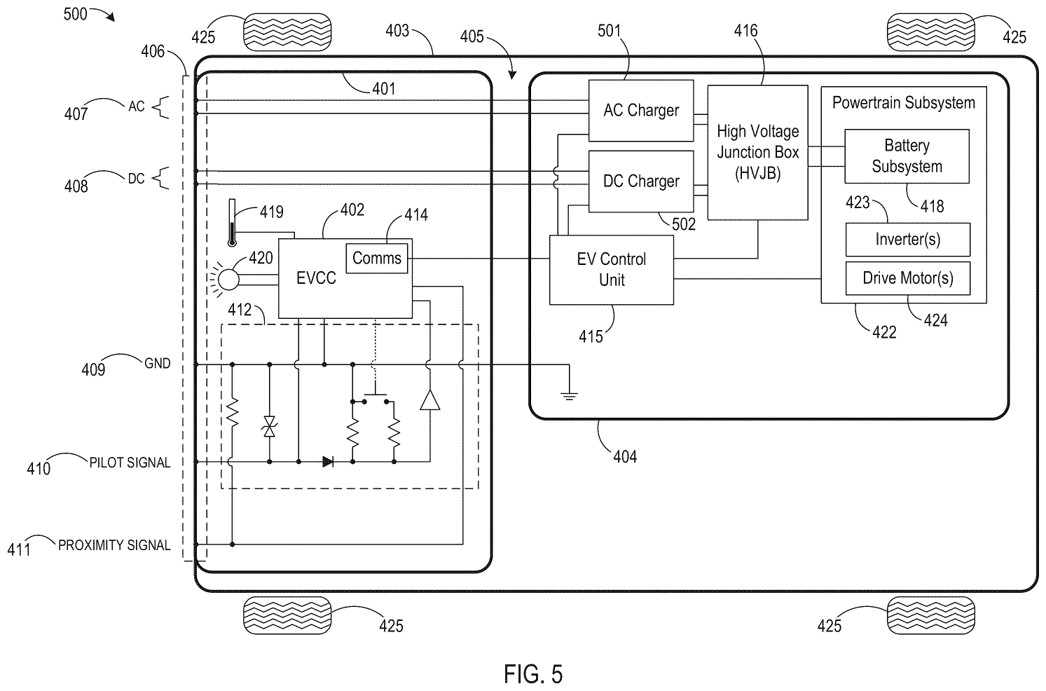

FIG. 5 illustrates an example architecture 500 of the electric vehicle of FIG. 4 in accordance with another embodiment and has same or similar components as those of EV 400. Such components in common share same reference numerals in the drawing and descriptions as described above.

Architecture 500 illustrates use of both the AC pins 407 and the DC pins 408 for changing the charging energy supplied by the EVSE (e.g., the charging station 101 of FIG. 1). In one example, the architecture 500 includes an AC power charger 501 (e.g., such as an onboard charge module (OBCM)) configured to convert AC charging energy into DC charging energy for charging the battery subsystem 418. The AC power charger 501 may be an implementation of the AC power charger 201 described with respect to FIG. 2. As such, the AC power charger 501 can allow the vehicle to be connected to an AC power charging source. In one example, the AC power charging source may be a household voltage supply of, for example, 120 VAC. The AC power charger 501 includes power switches and other circuitry for converting the input AC energy into DC energy. The AC-to-DC conversion may include boosting the converted DC energy into a higher voltage to match a voltage of the battery subsystem 418. The converted DC energy is supplied to the HVJB 416 for distribution as described in FIG. 4.

Also shown in FIG. 5 is a DC power charger 502 (e.g., such as a DC fast charging module (DCFC)) for converting DC charging energy supplied via the DC pins 408 to a different value. In an embodiment, the nominal voltage of the vehicle 500 may be higher or lower than the supplied DC charging energy (via DC pins 408). For example, the DC charging energy supplied by an EVSE may be at 800 VDC while the vehicle may be designed as a 400 VDC system or vice versa. Accordingly, the DC power charger 502 may be configured to convert the supplied DC energy via boost or buck conversions as appropriate. The DC power charger 502 may be an implementation of the DC power charger 202 described with respect to FIG. 2. The converted DC energy is supplied to the HVJB 416 for distribution as described in FIG. 4.

While both the AC power charger 501 and the DC power charger 502 are illustrated in the architecture 500, only one of these chargers 501, 502 may be used in some implementations. For example, a first implementation of the architecture 500 may by designed to ignore supplied AC charging energy and thus may not implement the AC power charger 501. Alternatively, a second implementation of the architecture 500 may not need DC-to-DC voltage conversion and may thus leave the DC power charger 502 out of the design. The EV control unit 415 is configured, in any implementation including either or both of the AC power charger 501 and the DC power charger 502, to control the chargers 501, 502 to convert supplied charging energy as needed.

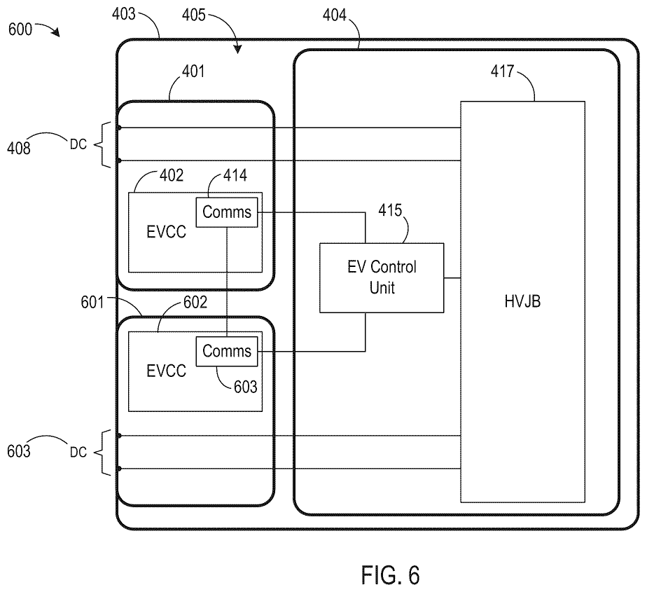

FIG. 6 illustrates an example architecture 600 of the electric vehicle of FIG. 4 in accordance with another embodiment and has same or similar components as those of EV 400. Such components in common share same reference numerals in the drawing and descriptions as described above. Further, some components are not shown in FIG. 6 to simplify the drawing and descriptions.

Architecture 600 includes the charge port 401 of EV 400. The charge port 401 is a first charge port. As shown, architecture 600 includes a second charge port 601 located in the space 405 between the vehicle exterior 403 and the vehicle chassis 404. The second charge port 601 includes its own EV charge controller 602 and DC pins 603. The EV charge controller 602 operates to control vehicle charging using DC energy supplied via DC pins 603 in a similar manner as the EV charge controller 402 and DC pins 408. The EV charge controller 602 includes a communications module configured based on a vehicle communication protocol (e.g., CAN) and communicates with vehicle communication subsystem 414 of the EV charge controller 402 as well as with the EV control unit 415. The use of multiple charging inputs (e.g., charge ports 401, 601) may shorten a charging time of the vehicle. While two charge ports 401, 601 are illustrated, three or more charge ports are also considered to be within the scope of this disclosure.

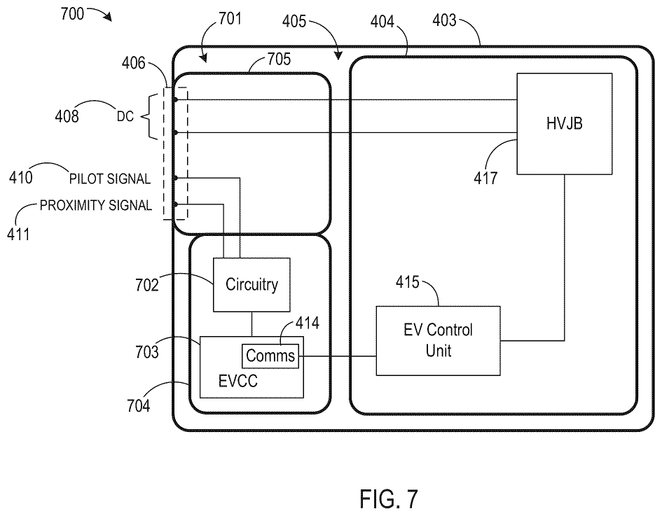

FIG. 7 illustrates an example architecture 700 of the electric vehicle of FIG. 4 in accordance with another embodiment and has same or similar components as those of EV 400. Such components in common share same reference numerals in the drawing and descriptions as described above. Further, some components are not shown in FIG. 6 to simplify the drawing and descriptions.

Embodiments of this disclosure shown and described with respect to FIGS. 1-6 include EVSE communication circuitry and an EV charge controller as components of a charge port (e.g., charge ports 104, 401, 601). In the embodiment illustrated in FIG. 7, the architecture 700 also includes a charge port 701 having circuitry 702 (e.g., communication circuitry 412) that facilitates communication with a charge station and an EV charge controller 703 as components of the charge port 701. In the architecture 700, the EVSE communication circuitry 702 and the EV charge controller 703 are placed within a charge controller housing 704 coupled to or placed adjacent to a charge port housing 705. The charge controller housing 704, similar to the charge port housing 705, is located in the space 405 between the vehicle exterior 403 and the vehicle chassis 404. In another embodiment, the EVSE communication circuitry 702 may be positioned within the charge port housing 705 while the EV charge controller 703 remains positioned within the charge controller housing 704. As with the charge ports 104, 401, 601 of FIGS. 1-6, the charge port 701 is considered to include the EVSE communication circuitry 702 and an EV charge controller 703, though the EVSE communication circuitry 702 and an EV charge controller 703 are positioned within an adjacent housing 704.

While some examples provided herein are described in the context of an electric vehicle, system, subsystem, circuit, or environment, the systems, components, and methods described herein are not limited to such embodiments and may apply to a variety of other processes, systems, applications, devices, and the like. Aspects of the present invention may be embodied as a system, method, device, and other configurable systems.

Unless the context clearly requires otherwise, throughout the description and the claims, the words “comprise,” “comprising,” and the like are inclusive meaning “including, but not limited to.” In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A. A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the present disclosure may include only some of the described embodiments. Accordingly, the invention is not to be seen as limited by the foregoing description but is only limited by the scope of the appended claims.

What is claimed is:

1. An electric vehicle (EV) comprising:
a battery subsystem; and
a charge port comprising:
a charge port connector configured to mate with a charging station connector of a charging station configured to supply charging energy to the battery subsystem;
a first communication circuitry configured to communicate with the charging station via the charge port connector based on a first communication protocol;
a second communication circuitry configured to communicate over a communication bus based on a second communication protocol;
a charge controller configured to control charging of the battery subsystem via the supplied charging energy based on a status of the battery subsystem.

2. The EV of claim 1, wherein the second communication protocol comprises a communication area network (CAN) protocol; and
wherein the second communication circuitry comprises a CAN transceiver.

3. The EV of claim 1, wherein the first communication protocol comprises an SAE J1772 protocol.

4. The EV of claim 3, wherein the charge port connector comprises:
a control pilot pin configured to communicate a control pilot signal between the charge controller and the charging station; and
a proximity pilot pin configured to communicate a proximity pilot signal between the charge controller and the charging station.

5. The EV of claim 4, wherein the control pilot signal and the proximity pilot signal are terminated within the charge port.

6. The EV of claim 1 further comprising:
a vehicle exterior comprising a plurality of panels; and
a vehicle chassis positioned within the vehicle exterior; and
wherein the charge port is positioned in a space between the vehicle exterior and the vehicle chassis.

7. The EV of claim 6, wherein the charge port connector is coupled with a first charge port housing; and
wherein the charge controller is coupled with a second charge port housing coupled with the first charge port housing.

8. The EV of claim 6 further comprising a junction box electrically coupled between the charge port connector and the battery subsystem.

9. The EV of claim 8 further comprising an AC-to-DC converter coupled between the charge port connector and the junction box and configured to convert an AC charging energy supplied to the charge port via the charging station into a DC charging energy capable of charging the battery subsystem.

10. The EV of claim 8 further comprising a DC-to-DC converter coupled between the charge port connector and the junction box and configured to convert a first DC charging energy supplied to the charge port via the charging station into a second DC charging energy capable of charging the battery subsystem.

11. An electric vehicle (EV) comprising:
a vehicle chassis;
an exterior panel coupled to and supported by the vehicle chassis, wherein a space is formed between the vehicle chassis and the exterior panel;
a vehicle control unit;
a battery subsystem;
a charge port coupled to the exterior panel within the space between the vehicle chassis and the exterior panel and comprising:
a charge controller comprising a vehicle communication module electrically coupled with a vehicle communication bus electrically coupled with the vehicle control unit;
a connector configured to receive battery charging energy from an energy source, the connector comprising:
a plurality of power pins;
a plurality of communication pins electrically coupled with the charge controller; and
a charge source communication module electrically coupled with the plurality of communication pins.

12. The EV of claim 11, wherein the vehicle control unit is positioned within an interior of the vehicle chassis.

13. The EV of claim 11, wherein the battery subsystem is positioned within the interior of the vehicle chassis.

14. The EV of claim 11 further comprising a high voltage junction box electrically coupled between the plurality of power pins and the battery subsystem; and
wherein the high voltage junction box is positioned within the interior of the vehicle chassis.

15. The EV of claim 14, wherein the high voltage junction box comprises a contactor electrically coupled between the plurality of power pins and the battery subsystem and configured to electrically couple the plurality of power pins with the battery subsystem.

16. The EV of claim 11, wherein the charge port is a first charge port; and
further comprising a second charge port coupled to the exterior panel within the space between the vehicle chassis and the exterior panel and comprising:
a charge controller comprising a vehicle communication module electrically coupled with the vehicle communication bus;
a connector; and
a charge source communication module electrically coupled with the second connector;
wherein the connector of the first charge port is electrically coupled with the connector of the second charge port.

17. A method comprising:
electrically coupling a charge controller with a connector of a charge port, wherein the charge controller is located within the charge port;
electrically coupling a charge source communication module with the charge controller and with the connector, wherein the charge source communication module is located within the charge port;
coupling the charge port to a vehicle exterior panel within a space between the vehicle exterior panel and a vehicle chassis.

18. The method of claim 17, wherein the charge source communication module is terminated at the charge controller.

19. The method of claim 18, wherein the charge controller comprises a vehicle communication module, and
wherein the method further comprises:
electrically coupling the vehicle communication module with a vehicle communication bus; and
electrically a vehicle control unit to the vehicle communication bus, wherein the vehicle control unit is located within an interior of the vehicle chassis.

20. The method of claim 19, wherein the vehicle communication bus comprises a controller area network (CAN) bus.
